(19) United States
(12) Patent Application Publication
(10) Pub. No.: US 2022/0141192 A1
(43) Pub. Date: May 5, 2022

(54) System and Methods for Path-Aware and Path-Assured Secure Virtual Private Lines and Secure Network Slices using Enhanced Digital Certificates in Multi-Vendor Multi-Domain Networks

(71) Applicant: SecureG, Sterling, VA (US)

(72) Inventors: Matthew Silveira, Placerville, CA (US); Carlos Solari, Sterling, VA (US); William C. Epstein, Port Angeles, WA (US); Russell Housley, Herndon, VA (US); Surya Kumar Kovvali, Carlisle, MA (US); Kevin Riley, Amesbury, MA (US); Sean Turner, Washington, DC (US)

(21) Appl. No.: 17/517,232

(22) Filed: Nov. 2, 2021

Related U.S. Application Data
(60) Provisional application No. 63/108,944, filed on Nov. 3, 2020.
(60) Provisional application No. 63/207,419, filed on Mar. 1, 2021.

(51) Int. Cl. H04L 29/06; H04L 9/32; G06F 21/33; H04W 12/069

(52) U.S. Cl. CPC H04L 63/0272; H04L 9/3263; H04L 63/20; H04L 2463/082; H04L 63/105; H04W 12/069; G06F 21/335

(57) ABSTRACT

Methods of configuring path-aware point to point secure network private lines over multi-domain, multi-operator virtual and physical networks through network elements that are compliant with PKI Digital Certificates (eDC) with metadata enhancements are disclosed. Secure Network Slices (SNS) may then be constructed by interconnecting SVPLs through a network aggregation device such as switch/bridge/router which allows different network policies on different segments of the network. A Digital Trust Broker is disclosed that bridges between multiple Authentication/Authorization frameworks of an enterprise and the security frameworks of multiple operators and service providers that provide Secure Virtual Private lines and Secure Network Slices. Additionally, the methods that identify that any traffic exchange with internet or between differing levels of SNS or SVPLs go through enhanced security bridge that enforces policies of high security enterprise are also disclosed.

This application claims priority of U.S. Provisional Patent Application Ser. Nos. 63/108,944 filed Nov. 3, 2020; and 63/207,419 filed on Mar. 1, 2021, the disclosures of which are incorporated herein by reference in their entireties.

### BACKGROUND

Multi-tenant datacenters, Network Function Virtualization (NFV), and Cloud Services are steadily replacing traditional purpose-built hardware intensive platforms in enterprise datacenters with tightly managed perimeter security. Server virtualization with Virtual Network Functions (VNF) such as Webservers, mail servers, application servers and others, are moving to dense compute, memory, storage, databases in Cloud and Network Functions Virtualization (NFV) paradigms, where several network, Storage, CPU and other HW and software resources are shared by many client enterprises and users. This sharing increases security vulnerabilities, since when a service provider's security is compromised, it could affect multiple tenants. While cloud or network service providers may have methods to protect tenants using tunneling, VXLANS, encryption and other techniques, these protection methods end when the tenant traffic need to be forwarded or received from internet in the multi-tenant environment. As the Wireline and Wireless applications that use network services in IOT, Home Automation, Vehicular Communications are growing astronomically, as part of 5G standards, 3GPP defined Network Slicing to accommodate diverse QOS needs to support traditional and Micro services on the same infrastructure. With Network Slicing in 3GPP Standards, an operator supports multiple services with different QOS on the same wireless and wireline network.

When a user or an application attempts to use trust assured secure network paths to access remote servers in Software Defined Network (SDN), Cloud or remote enterprise locations, it is essential that such on-ramping at both ends of the network paths have the required credentials (both authorization and authentication) at both ends. For example, a high security database server operated by the Department of Defense may require the server is accessible only via Secure Network Slices (SNS) with high Level security policies, only from certain GEO Locations, or only by specific client applications, client devices and users with the required security credentials.

User, User department, Server, specific data Read, Write, Modify, Delete, and other access policies are managed by a plurality of authorization/authentication servers and methods, such as passwords, encryption, multi-factor authentication (MFA), Captcha, user secrets, department secrets etc., to minimize security vulnerabilities.

5G Architecture teaches the concept of “Network Slices” (NS), by which an operator offers network services with different Quality of Service (QOS) such as bandwidth, delay, priority etc., on the same physical and virtual network, compute, memory and storage resources for differing vertical application uses, such as IOT, Healthcare, V2X and others. The network slices may span across an operator's access and core networks. The network slices facilitate offering Macro and Micro services with different QOS requirements on the same infrastructure. The creation and management of network slices is specific to the operator.

However, there is a need to further expand this concept to orchestrate authentication and authorization and other security policies for logical SNS paths. Further, it would be beneficial if there was an entity that bridges the authorization and authentication policies of a high security enterprise across plurality of policy servers of the enterprise and leased services.

### SUMMARY

Previously, Secure Network Slices (SNS) were disclosed with transit path security and trust assured via PKI Digital Certificates with enhanced metadata that includes provenance and other attributes for each transit physical and virtual network element. The current application defines “Slice Certificates”, that orchestrate authentication and authorization and other security policies for logical SNS paths, metadata enhancements to Digital Certificates. It is envisioned that the slice certificates are stored in the devices that originate and terminate the SNS paths, such as a customer premise equipment (CPE) device at a secure enterprise location, or a laptop or mobile device with trust assured applications that are allowed to use these paths.

Further, the current disclosure identifies creating path assured point to point secure virtual private lines (SVPLs) that require allowing only those devices (end points and transit devices) that hold the enhanced digital certificates in the transit path. SNS logical networks described herein may be constructed by connecting SVPLs to a physical or logical network element, such as a virtual network function (VNF), in an enterprise, Cloud or SDN datacenter and managed by a high security enterprise or a high security network service provider. SVPLs facilitate using different security policies between different departments and/or between different network functions (for example, to database servers, application servers, internet and other devices) or between different segments of the SNS.

Additionally, the present disclosure describes a Digital Trust Broker (DTB), that bridges the authorization and authentication methods of a high security enterprise across plurality of policy servers within the enterprise and leased services (for example, cloud hosted services, VNFs and others). Slice Certificates orchestrate the security policies to guide the DTB in assuring the security policies in a multi-domain, multi-operator network that brokers security between multiple policy systems.

According to one embodiment, a method of creating a Secure Network Slice, which is a multi-point secure network, is disclosed. The method comprises determining one or more forwarding paths through the network that connects two points; querying each network device along each of the one or more forwarding paths to determine if each network device is trust assured and comprises an enhanced digital certificate, wherein the enhanced digital certificate comprises metadata regarding a provenance of the network device; defining the secure virtual private line as a forwarding path between the two points wherein each network device in the forwarding path has an enhanced digital certificate having desired parameters; and using an aggregation device to connect two or more secure virtual private lines to create the Secure Network Slice. In some embodiments, the multi-point secure network comprises at least one of an enterprise network, a cloud provider, a communications service provider, a SDN, physical/virtual network segment, a 5G radio access network and a 5G core network. In some embodiments, the metadata is selected from the group consisting of hardware or software make; hardware or software model or release; a region where the network device is manufactured; and a location where the network device is manufactured. In certain embodiments, the metadata comprises geolocation information regarding where the network device is deployed. In some embodiments, the metadata comprises a list of security policies supported by the network device. In certain embodiments, the two of more secure virtual private lines are at different security levels and the aggregation device comprises an enhanced security bridge. In some embodiments, a mobile device is configured to access the secure network slice, and the mobile device comprises an enhanced digital certificate and authenticates a user of the mobile device prior to allowing access to the secure network slice. In some embodiments, the user is authenticated using at least one of multi-part authentication, device screen lock pass code, speaker recognition, fingerprint recognition, and facial recognition.

According to another embodiment, method of maintaining security in a Secure Network Slice, which is a multi-point secure network, is disclosed. The method comprises creating a Secure Network Slice, wherein the Secure Network Slice includes an enhanced security bridge, wherein the enhanced security bridge serves an interface between other devices in the Secure Network Slice and the internet; and forcing any traffic from the Secure Network Slice to or from the internet to pass through the enhanced security bridge. In some embodiments, the enhanced security bridge is configured to perform deep packet inspection. In some embodiments, the enhanced security bridge only allows traffic at a certain security level to access the internet. In some embodiments, the enhanced security bridge allows only certain end points to access the internet.

According to another embodiment, a Digital Trust Broker is disclosed. The Digital Trust Broker comprises a plurality of functional software modules and is adapted to interact with an Operations and Management Platform (OMP) associated with an external operator to create and maintain a Secure Network Slice, wherein the Secure Network Slice is a logical network in a multi-domain network. In some embodiments, when a user session attempts to access the Secure Network Slice, the Digital Trust Broker validates the user. In certain embodiments, when a user session attempts to access the Secure Network Slice, the Digital Trust Broker interacts with consumer premise equipment (CPE) to obtain security policy metadata of a Slice Certificate, and based on the Slice Certificate, determines which applications and departments of an enterprise are allowed to access the Secure Network Slice. In some embodiments, the Digital Trust Broker gathers device forwarding behavior for specific interfaces in the Secure Network Slice, and based on historical information, detects an anomaly in an operation of the device. In some embodiments, the Digital Trust Broker monitors packet volume, byte volumes, frequency, IO Read, IO Activity generated during a session, for each client server interaction by a user and user device. In certain embodiments, after the Secure Network Slice has been created, the Digital Trust Broker creates new transit paths due to configuration changes. In some embodiments, after the Secure Network Slice has been created, the Digital Trust Broker revalidates each device in the Secure Network Slice.

### BRIEF DESCRIPTION OF THE DRAWINGS

For a better understanding of the present disclosure, reference is made to the accompanying drawings, in which like elements are referenced with like numerals, and in which:

FIG. 1 is a context diagram that outlines the PKI Infrastructure components of each vendor, carrier, SD-WAN, and Cloud Provider.

FIG. 2 shows path assured Secure Virtual Private lines of an enterprise through multi-domain, multi-operator network.

FIG. 3 shows an enhanced Security Bridge (eSB) that enforces enhanced security policies while exchanging traffic between SNS and the internet or between different security level SNS or SVPLs.

FIG. 4 shows the placement of Digital Trust Broker and the associated eco-system components in a Security Operations Center of an enterprise that uses SVPLs and SNS.

FIG. 5 is an example placement of a multi-domain security system component close to the clients in Amazon AWS Cloud Environment.

FIG. 6 shows an example overview of Digital Trust Broker deployment architecture.

FIG. 7 shows functional components of Digital Trust Broker.

FIG. 8 shows example inputs that Digital Trust Broker receives and the actions or triggers to the eco-system components.

FIG. 9 is an overview of authentication and authorization frameworks in 5G and Non-5G networks.

FIG. 10 shows an example configuration to illustrate the operation of the DTB in brokering trust between plurality of Authorization and Authentication systems.

### DETAILED DESCRIPTION

The current disclosure defines additional metadata policy attributes in enhanced Digital Certificates that transit network elements may hold for carrying traffic for Secure Network Slices, previously identified in U.S. patent application Ser. No. 17/321,405, the disclosure of which is incorporated by reference in its entirety. The additional policy attributes include geolocation of the device in operation, the ability to restrict mirroring of traffic to specified ports only for troubleshooting and flow analytics, the ability to filter or allow forwarding of traffic to allowed ports (next hop ports or for data-collection) only, and controlled rerouting. The path assured network slices may be point-to-point Secure Virtual Private Lines which allow multi-point SNS to be constructed by connecting multiple SVPLs to enterprise managed or service provider managed network element using the client defined network policies. This facilitates using different policies for different SVPLs; for example, SVPL to a high security database server may require transparent service such as dark-fiber, a wavelength service on Optical/DWDM multiplexing on fiber or a MPLS connection or a higher security level than other SVPLs.

The Digital Trust Broker disclosed herein bridges between authentication and authorization policy servers when users, user devices, user applications, or enterprise applications (for example daily backup) initiate traffic flows through the SVPL or SNS logical networks. The “Slice Certificate” for a SNS or SVPL orchestrates the policies required while using the SNS/SVPL paths. For example, a specific slice may require only R&D department devices and users are allowed, or any users must be validated via multifactor authentication, or approval by department head or multiple personnel similar to approvals in a bank for higher amount transactions.

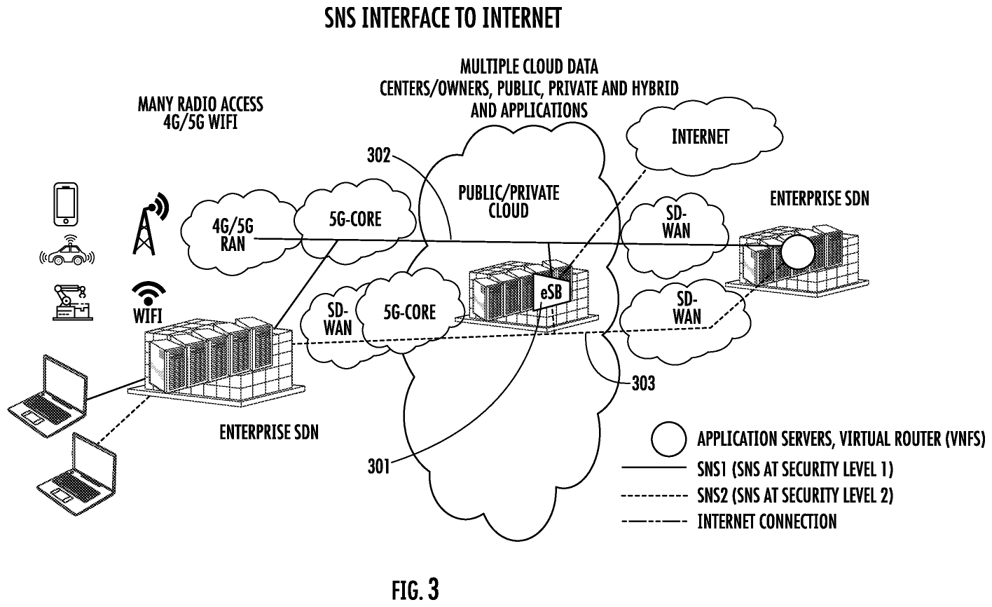

Enterprises that require high security often require accessing the internet or using internet services. Connecting to the internet and using internet services may require decrypting and/or encrypted content or removing tunnels, since the content need to be routed to application servers in the internet/Cloud based on the IP Address in the user plane IP Packets. While some websites, and applications such as HTTPS, SSH and others, use encryption, this encryption ends at the website or application provider. When SVPL/SNS connect to the internet, any security compromises, malware, botnets, and infected applications may compromise the security of SVPLs and SNS. To minimize security vulnerabilities, the current disclosure identifies that all traffic transmitted or received from internet first passes through a security system component termed the eSB 301 (Enhanced Security Bridge), as shown in FIG. 3. This eSB 301 enforces policies orchestrated by the enterprise as described in more detail below. The eSB 301 is similar to a Firewall at enterprise network boundary with the difference that it interfaces with SNS/SVPL, holds an eDC, assures required policies per certificate metadata and additional security policies for that security level.

Thus, the present application describes various enhancements that provide improved security. These enhancements include:
Secure virtual private lines (SVPLs)
Security Policy enhancements for Secure Network Slices and SVPLs
Authentication and Authorization
Digital Trust Broker
Slice Certificates
Orchestration of Security Platform Components

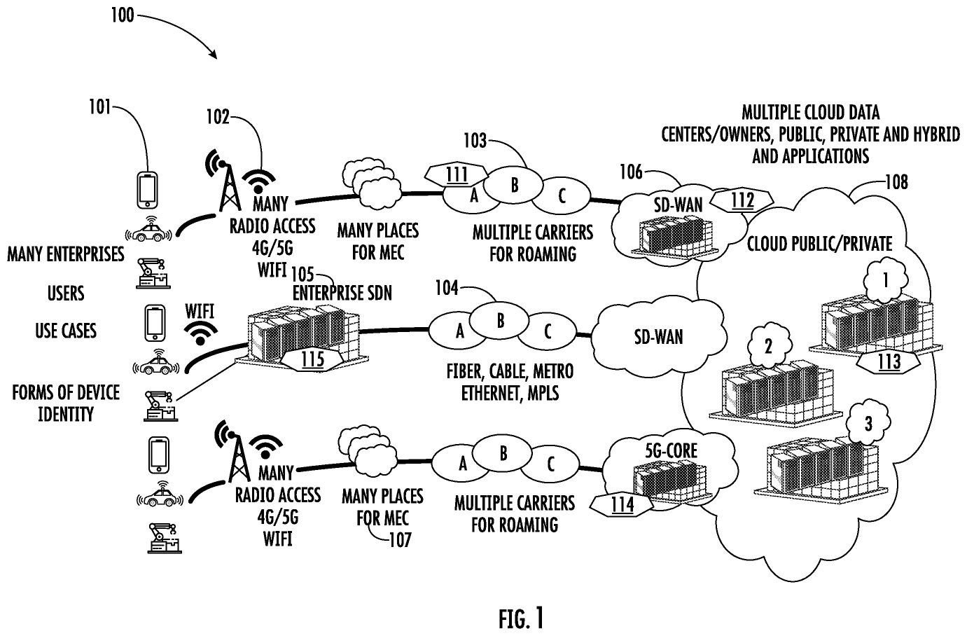

Having defined various embodiments, a detailed description follows. FIG. 1 is an example network infrastructure 100 where the methods disclosed herein may be deployed. The network infrastructure 100 includes client devices 101, which may include mobile telephones, automobiles, equipment, computers and other devices. The network infrastructure 100 also includes access networks 102, which include wireless base stations, WiFi access points and others. Further, the network infrastructure includes multiple carriers 103, and transport mechanisms 104, such as fiber, cable, metro ethernet and MPLS. Other components, such as software defined networks (SDN) 105, wide area networks (WANs) 106, and mobile edge computing devices (MEC) 107 may also be disposed between the client devices 101 and the cloud 108.

FIG. 1 also shows the PKI Infrastructure components 111-115 of each vendor, carrier, SD-WAN, and Cloud Provider. The PKI infrastructure components 111-115 may be hosted in virtual networks, cloud, or private networks, and the PKI infrastructure components 111-115 may include Certificate Authority, Trust Anchor, OCSP Server and others.

Each of the devices described above may be implemented as a hardware module. In some embodiments, this hardware module comprises a processing unit, in communication with a computer readable non-transitory storage medium. This storage medium may comprise instructions that enable the component to perform the functions described herein. In certain embodiments, two or more of the components described above may be incorporated into a single hardware module, and are implemented as software components.

Each of the enhancements listed above will be described in more detail.

### Secure Virtual Private Lines (SVPLs)

Communication Service Providers (CSPs) such as Comcast, Verizon, and others, provide virtual private lines (VPLs), and Ethernet Virtual Private Lines (EVPLS) from one location to another or to the internet for enterprises. Traditionally, these private lines used to be T1, T3, OC-N, DWDM/Dark fiber and others, where the data transported is transparent to the transit network. With the growth of SDN, NFV, Cloud Services, these private line services are replaced by Ethernet/IP transport services over NFV and the Cloud where the transit network uses a plurality of hardware and layered software for similar services, and the transit paths are managed by the service provider.

Secure Network Slices are described in U.S. patent application Ser. No. 17/321,405. Briefly, Secure Network Slices carry micro and macro application services in the evolving 5G Network Paradigm. Both the end devices and network partners have certificates (specifically eDCs, which are X.509 Digital Certificates with the enhancements identified) on their devices, assigned by an enhanced Certificate Authority (eCA). The metadata of the enhanced digital certificate (eDC) dictates the provenance and other metadata attributes that are supported. The metadata includes, but not limited to:
(a) Hardware and/or Software Make
(b) Hardware and/or Software Model/Release
(c) Region where device is manufactured
(d) Location where device is manufactured
(e) Other Provenance Requirements
(f) Priority/Service Class
(g) QOS parameters (latency, bandwidth, reliability)
(h) Service duration
(i) Service criticality, redundancy and availability
(j) Network device type (Bridging, Switching, Routing, VXLAN, MPLS)
(k) Types of routing (Source Routing, Hop-by-hop routing)
(l) Hierarchy levels of network slices (sub-ordinate network slices with subset of QOS and Policies) for micro services. The subordinate slices may use different QCI levels within RAN with dedicated RABs for certain QOS levels.
(m) Device operation and Certificate type (User/Client, network edge, operator edge (connects two operator networks, and the operator names)

Of course, additional metadata may also be incorporated into the eDC, and the disclosure is not limited to only the listed metadata.

The metadata is intended to include both the Branded Device Model information, and the Original Manufacturer information that manufactured the brand; for example, Company A in China manufacturing products for NOKIA in USA. While the basic X.509 digital certificates with standard attributes are installed during manufacturing, different portions of the metadata extensions may be onboarded by the original manufacturer prior to shipment or onboarded post manufacturing at a reseller location, at an operator procurement site, or in device operational location in coordination with the trust assured entities. The method of onboarding the entirety or subset of the above metadata onto Digital Certificates at different stages before the device is put into operational use to carry SNS traffic is outside the scope of the current disclosure.

By reviewing each component's eDC, a secure network slice, made up of only components that meet certain criteria, may be constructed. Further, the interfaces of each component can be queried to ensure that the interface connects to another component that possessed the necessary eDC. Thus, each component and each interface on that component can be checked to ensure that it may be part of the secure network slice.

Point-to-Point Secure Network Slices with security policies orchestrated by enhanced digital certificates that contain the security policy metadata provide end to end virtual private line service with enhanced transit path assured private line services. The client selectable security policy enhancements may include:
transit path selection,
visibility of transit paths hop-by-hop,
type of network element at each hop,
its location, region, vendor, model, revision,
HW/SW versions of the base system, and
any plugged linecards, O/S, Hypervisor, VMs, Containers, Applications that provide the SVPLs, hop-by-hop and end-to-end encryption, that substantially increase the trust and security.

With these Secure Network Slices, the service provider that offers secure network slices manages virtual or physical switches/bridges/routers that connect secure network slices.

The current disclosure adds the concept of Secure Virtual Private Lines. SVPLs facilitate additional levels of flexibility, such as:
(1) leasing SVPLs and connecting to physical/virtual switch/bridge/router at enterprise's physical or virtual data centers, and
(2) using a different vendor switch/bridge/router and their management services.

For example, an enterprise with facilities at 3 different locations could lease SVPLs for mesh connectivity and an additional 1 to 3 links for internet connectivity. The enterprise may then connect them with virtual switches in NFV or Cloud Datacenters. This facilitates different policies on different segments, for example, different policies on access SVPLs, aggregation links, trunk links, and links to application servers. The policy could require transparent service such as dark-fiber, or a wavelength service on Optical/DWDM multiplexing on fiber on trunk/aggregation links. SVPL in combination with SNS facilitates different security policies for different segments of a logical network.

For example, a SNS at security level 1 could connect to an aggregation network device, and the aggregation device may connect to an enterprise database server using an SVPL with higher level of security policies, and to an internet gateway with different policies.

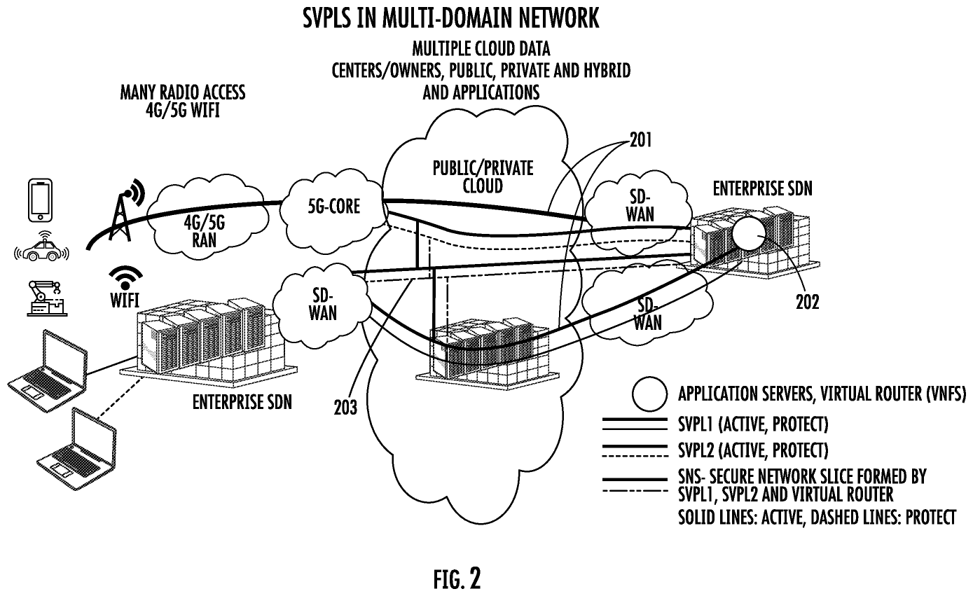

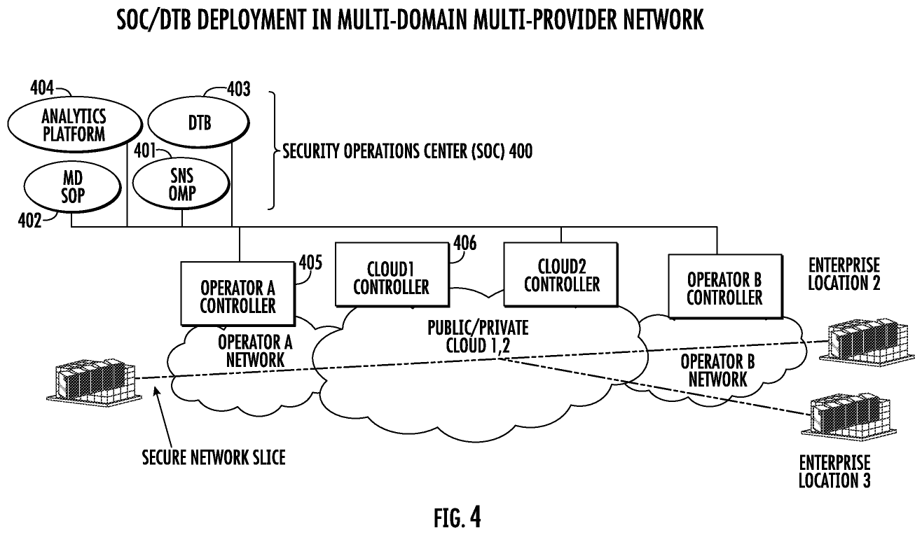

FIG. 2 shows an example of path assured Secure Virtual Private Lines of an enterprise through multi-domain, multi-operator network. Each SVPL 201 is setup with redundancy for transit network failures, similar to Optical Networks. The redundant path may be setup as Active/Protect or Active/Active. FIG. 2 shows two SVPLs 201 connected to a physical or virtual router 202 to form a Secure Network Slice (SNS) 202. The failure protection may be hop-by-hop or end to end. In hop-by-hop protection, in the transit device, an alternate security assured path is set up so that the device forwards to the alternate path if next hop link failure detected. With end-to-end protection, if a failure is detected, transit network elements or operations and management platforms notify the SNS-OMP 401 (see FIG. 4), which triggers a path change. Alternatively, if security compromises are detected in one or more transit networks (for example, in a specific cloud), SNS-OMP 401 triggers switching to protection path through different Cloud and Operator Networks. The protection and switchover policies are specified for plurality of security levels in enhanced digital certificates as object identifiers.

Key benefits of SVPLs compared to traditional Virtual Private Line and Ethernet Virtual Private Line (VPL/EVPL) services are that:
the transit network equipment (NEs) are trust assured;
Client Enterprise can validate and track (path hop-by-hop);
unknown flows do not enter; and
secure flows do not go to arbitrary devices that are not trust assured.

Client selectable transit paths facilitate avoiding sites and transit networks that may have been security compromised during the lifetime of SVPL or SNS. For example, if XYZ Cloud is found to be security compromised, the Client may select a path through ABC Cloud. Real-Time detection of compromises may be by periodic validation of enhanced certificate policies or by Analytics/ML of edge or transit flow headers (for example collected via NetFlow/IETF-IPFIX) or external sources in the service provider or other eco-system components.

To set up a transit path-aware SVPL with redundancy between two locations or between one location and a VNF server (for example, a cloud hosted application server, such as a mail server or database server), an enterprise that requires high security, negotiates with access network service providers, such as AT&T, Verizon, COMCAST and others, for network services and access to each of the transit network operations and management platforms to determine each of the transit network elements. Each network and cloud service provider may have their own Network Controller and Operations and Management Platforms. The Secure Operations Center 400 in FIG. 4 shows functional elements such as Secure Network Slice Orchestration and Management Platform (SNS-OMP) 401, Multi-Domain Security Operations Platform (MD-SOP) 402, Digital Trust Broker (DTB) 403, and Analytics Platform 404. The functional components may be Physical or Virtual Elements in a service provider NFV framework, or in a public or private cloud. These components interact with the operator and Cloud service providers' Network Controllers and Operations and Management platforms (OMP) 405.

Setting up SVPLs is similar to setting up a SNS, as described in U.S. patent application Ser. No. 17/321,405, with the difference that a point-to-point virtual network is set up between two physical or virtual endpoints, such as VNFs. The following examples outline steps involved in setting up Secure Virtual Private Lines.

Setting up an SVPL between enterprise locations requires:
(a) assuring that each eligible transit device holds an enhanced digital certificate (eDC);
(b) assuring that the interface that it connects to also holds an eDC; and
(c) determining the geographical location of the device before allowing the device and the interface to carry SVPL traffic.

This requires determining the identity of communication service providers and cloud data centers in the proximity of each of the enterprise locations and determining which of the transit NEs carries the eDCs by interacting with the corresponding network controllers & management platforms 405 (see FIG. 4) and cloud controller & management platforms 406. It further involves determining the transit paths in each of the eligible networks using applications such as, “trace route-all”, that provides IP routes, and then determining which NEs in the transit path hold eDCs, identifying which NE interfaces connect to another NE that also holds eDC, and marking each such interface in each NE as an eligible interface (port). This process marks eligible NEs, and eligible ports in each NE that could carry the SVPL traffic. For setting up a SVPL between client enterprise locations, the client enterprise may specify transit service providers (such as CSPs, SDN, Cloud providers) and the transit NEs in those networks. Multi-point SNS networks may be constructed by connecting multiple SVPLs to physical or virtual Aggregation Network Devices, such as Switches/Bridges/Routers, Application Proxies or Servers in enterprise locations or Cloud/SDN provider managed VNFs. The aggregation device may operate at the transport level if it is connecting multiple logical networks at the same security level. Alternatively, the aggregation device may utilize deep packet inspection (DPI) functions if the aggregation device bridges between multiple security levels or between SNS or SVPL and internet. The aggregation device that bridges between multiple security levels is termed “Enhanced Security Bridge (eSB)”, as shown in FIG. 3. FIG. 3 shows an eSB 301 that is used to connect a first SNS 302 and a second SNS 303. As shown in FIG. 3, these SNS's may be at different security levels. Thus, the eSB 301 is responsible for ensuring that the security policies of the more secure SNS are not violated by the other SNS. DPI may be utilized for this function.

A communication service provider may provide network paths to multiple cloud service providers and provide visibility to the transit path via their Network Controller and Management platforms 405. A client enterprise that uses SVPL may interact with CSPs via a Digital Trust Broker (which is described in more detail below) to determine the NEs that hold eDCs, to connect to the cloud entry points, and navigate through the Cloud Network Controller and Management platform 406 to determine transit NEs that could carry the SVPL and SNS traffic and mark eligible ports similar to that described above. The client enterprise could then setup SVPL or SNS using the eligible ports through the CSP and Cloud controllers.

Certain CSPs, SDN Service providers, and Cloud service providers may not provide visibility within each network element down to the physical level, and may only provide visibility to virtual element level, such as to specific VMs in a Network Element, or VNFs. In this case, for selecting the eligible Virtual Network Elements, it is essential to determine such virtual elements hold the eDCs, and also determine next-hop elements that carry the eDCs and mark the corresponding network elements and virtual ports. The client enterprise could then setup SVPL or SNS similar to process described above. Such validation needs to be performed while setting up the SVPL or SNS, or when network configuration changes due to link/interface failures, or transit network outages, or when a client requires high level of security and requires revalidation before using a slice for highly sensitive data transfers or operations on such sensitive data. The Digital Trust Broker (DTB) provides UI and client APIs and coordinates with operator devices to provide this functionality.

Mobile devices could connect to a SVPL via a physical or virtual edge device (VNF) that ensures that the user and the user device are trusted by using one or more of a plurality of methods such as ensuring that the device holds an eDC, and/or validating the user profile to ensure the user is allowed to use the specific security level. User and user device authentication could use plurality of mechanisms such as multi-part authentication, device screen lock pass code, speaker recognition, fingerprint recognition, facial recognition and others. While these authentication mechanisms for assuring the validity of the user identity and user device exist, coupling these to a security level based on user profile attributes, and allowing connectivity to a SVPL or SNS at a specific security level based on that authentication are novel.

As an alternative to the paragraph above, a mobile user could initiate setting up or elevating to a higher-level security SVPL or SNS. In this case, the user would connect to a lower security level SVPL/SNS and then initiate elevating to a higher security level to connect to a specific server or a remote site. In this case, the user and the user device will have the corresponding eDCs for the specific security level. Additionally, the security policy could restrict the user access from specific geographic locations/regions, and the certificates may contain metadata specifying allowed and/or prohibited locations/regions.

It is important to note that the above descriptions are examples of setting up SVPLs and SNSs by a client enterprise, and the methods could be expanded to cover additional use cases with the methods identified herein. As an alternative to an enterprise setting their own SVPLs and SNS's, network operators could provide these services and provide visibility to underlying geographical and network element transit paths and provide client orchestration mechanisms.

A SNS may be constructed by first setting up multiple point to point SVPLs between multiple end points and then connecting the SVPLs to an aggregation device such as a Switch/Router/Bridge or Application Proxies/Servers. This method facilitates bridging between SVPLs (or SNS) at different security levels. For example, a security enterprise may require transit path devices to be from Vendor “A” manufactured in US only, and one of the enterprise partners may be in a remote region/country and the transit networks/cloud service providers to that region may not have any paths that satisfy that criterion. In that case, the enterprise may use a SVPL at a different security level that allows “Vendor B” devices manufactured in a different region and interface to high security level SNS through an enhanced Security bridge that performs the additional security policies identified herein. Examples of such security policies are:
(a) requiring all traffic between the two security levels go through a traffic analysis device,
(b) permitting such traffic only when the enterprise IT personnel explicitly permit via authentication methods such as multi-factor authentication (MFA), or
(c) limiting the volume of traffic or resources that are exposed to minimize security compromises.

Security Policy Enhancements for SNS and SVPLs

U.S. patent application Ser. No. 17/321,405 discloses metadata enhancements such as provenance data to digital certificates for enhanced Security Policies to provide for Secure Network Slices. The current disclosure identifies additional metadata and security policy enhancements in enhanced digital certificates (eDCs). The security policies may be explicitly specified by object identifiers or implicitly by a specific security level, or as security policies in eDCs. The enhancements may be generic (such as device serial number, model, hw/sw version) or device type specific, for example, different policies for routers, for application servers and for other devices.

When setting up SNS, the metadata in the X.509 certificate is used to select devices that comply with the enhanced security policies. The present application extends these methods to setup SVPLs and identifies additional factors while setting up SVPLs or SNS. These are:
(1) Each X.509 certificate includes an extension that lists the security policies that are required to be supported by that device. For example, a device might support three policies (SP001, SP004, SP007). Under this approach, the device may be used to provide a network slice under any of these three policies, and it may not be used to provide a network slice under SP002.
(2) Each X.509 certificate includes an extension that lists the attributes of the device. For example (ATTR01=A, ATTR03=7, ATTR08=Q). Network slice security policies are defined in terms of acceptable criteria for some or all the attributes. For example, a security policy might require ATTR01 to be A or B, but not C. For another example, a security policy might require ATTR01 to be A, and ATTR03 to be greater than 5. Under this approach, the device may be used to provide a secure network slice if the attribute values in the certificate extension are acceptable under all the security policy criteria.

The security policies identified need to be assured and enforced by the transit service providers (CSPs, Cloud Providers). The additional policies place additional constraints on the flexibility while migrating services within the service provider network for load balancing and other resource optimizations for best quality of experience by the users and monetization returns to the service providers. Thus, it is envisioned that for services with enhanced security policies, service providers charge differently similar to pricing based on QOS. For greater flexibility to the users and to balance between the cost tradeoffs, the secure network slices may be at different levels, for example (SL1/SL2/SL3: Low, Medium, High, respectively). In addition to the policies previously identified, the following additional security policies are possible:
(a) Packet forwarding and processing changes to already assured network elements, and devices only.
(b) When interfaces go down or traffic needs to be redirected for network tuning, the transit network element notifies the SNS Operations and Management Platform 401 to initiate path reconfiguration.
(c) Each transit device provides trust assured device Geolocation Information, such as location configuration information (LCI) in the operational network so that the client enterprise or users could select specific locations/regions. The LCI may be embedded as an additional attribute to an eDC while installing the device in the operational network. The methods of onboarding the metadata and policies are outside the scope of current disclosure.
(d) A policy may be enforced such that the transit network element does not mirror or replicate traffic on interfaces selected for SVPL or SNS to other interfaces or only mirrors to specific validated interfaces only. Such mirroring could be entire packet replication or replication of specific headers for network analytics.
(e) A policy that the device supports content aware processing and filtering methods in transit network devices, application servers, and devices that bridge between multiple security levels, for example between SNS and internet or between different security levels of SVPLs or SNS or between SNS and SVPL, in the same service provider network or between 2 different service providers.
(f) Digital Trust Broker bridging between Authentication (Device) and Authorization (User): Users and User devices are allowed to use SVPL or SNS only after their identities validated with their corresponding eDC or other authentication methods such as Multifactor Authentication, User Tone Recognition, Facial Recognition, CAPTCH check, Screen Lock, Fingerprint recognition and others.

### Authentication and Authorization

High Security enterprises use a plurality of Authentication and Authorization frameworks, such as PKI, OAUTH2.0, MFA and others, to validate users, user devices, and different computing and storage devices. The security requirements could be multiple security levels depending on the departments, user's security level (for example DOD classified, secret, top-secret, etc.), and the types of data or resources the users are accessing. User authentication (verifying user identity), and authorization (types of resources, services, data that the user is allowed to access) use password protection, MFA, biometrics and other techniques, and use policy servers protected and managed by the enterprise IT and Security departments. User Authentication and Authorization may change frequently since the users may move between different departments and companies. Similarly, the systems, software and applications and services they use may be developed and managed by the enterprise—thus requiring trust verification and assurance by their IT and security departments. However, some of the hardware devices, and some software such as the operating system, applications, and other components may be by different system and hardware vendors manufactured at regions that the enterprise does not control and manage. Authentication of such devices and software need to be assured by verifiable trust authorities according to PKI Standards. PKI methods use Digital Certificates embedded in physical or virtual devices (for example, Processor Subsystems, OS, browsers, servers etc.) that use asymmetric or symmetric keys and are issued by Certificate Authorities. When user or applications (such as daily backup) in a high security enterprise attempt to use SNS or SVPL that connect to sensitive resources, such as databases and application servers, it is essential that the user and application credentials are validated by enterprise authentication and authorization systems. Further, the devices in the network paths must be trust assured via eDCs. Additionally, when SNS/SVPL paths at certain Security level are accessed, each such access is validated according to the policies of the specific SNS or SVPL as orchestrated by the slice certificate. The Digital Trust Broker facilitates this brokering function.

### Digital Trust Broker (DTB)

The Cloud/SDN/NFV environment that a high security enterprise uses may traverse a plurality of network and compute domains operated by multiple service providers with a plurality of different Authentication and Authorization frameworks, such as PKI, OAUTH2.0, and others. Each of the corresponding service providers will have their own trust and security frameworks for carrying client traffic. The setup and validation of transit paths for secure networks slices requires trust assurance via a federation of private and public network providers by selecting equivalent policies in each provider network and mapping to the required policies and identifying segments that do not have acceptable policies so that the orchestrator could choose alternative transit paths. The Digital Trust Broker interfaces with plurality of service provider Policy and Operation Control Systems (PCFs) and Management platforms to assure security policies, analyze certificate flows (e.g., OCSP flows), identify anomalies via ML algorithms, and initiate corrective actions.

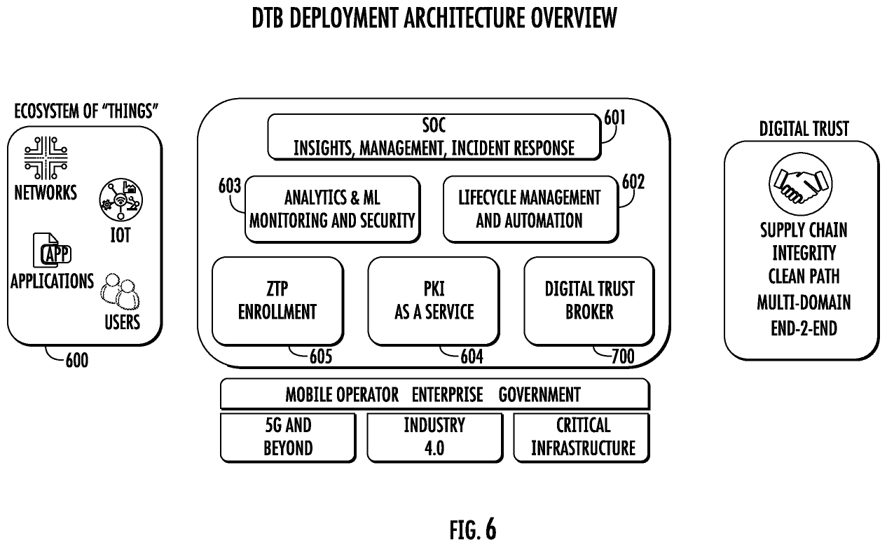

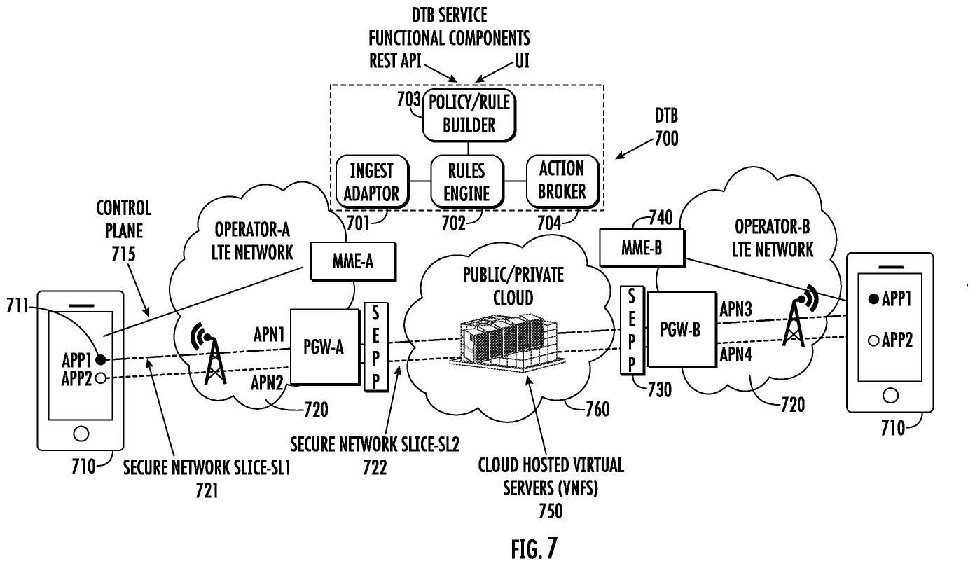

FIG. 6 shows an example overview of a DTB deployment architecture. It shows the eco-system 600 of components that the Digital Trust Broker 700 interacts within the Security Operations Center (SOC) 601. The Lifecycle Management function 602 manages the creation, validation, and maintenance of SVPLs and SNS according to the policy attributes in the eDCs. The SOC 601 presents the User Interface for operations management personnel providing insights, such as notifications, alarms and other functions, based on the information computed by the Analytic & Machine Learning (ML) Modules 603, for SNS and SVPL paths created and managed by Lifecycle Management functions 602. The PKI as a Service module 604 facilitates generation, delivery and management of enhanced certificates (eDCs). The ZTP (Zero Touch Provisioning) module 605 facilitates configuration and onboarding of new devices into operational networks. The Digital Trust Broker 700 interacts with operator management platforms to configure monitoring and data collection for PKI Certificate flows, SNS/SVPL traffic flows (for example, IPFIX flows from network interfaces), information on IO activity in application servers and other data that serve as inputs to the Analytics & ML module 603. The Digital Trust Broker 700 receives results of Analytics & ML Module 603 and uses the Rules Engine 702 (see FIG. 7) to send notifications and action triggers to the eco-system 600.

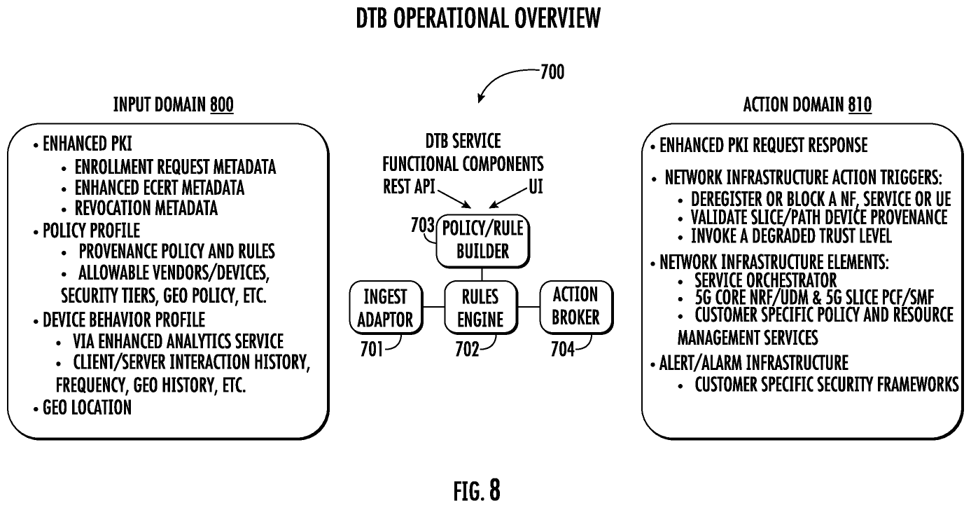

FIG. 7 shows functional components of Digital Trust Broker 700. The DTB 700 is a combination of several functional software modules, and the modules may be deployed on physical or virtual computing systems managed by the high security enterprise. The DTB 700 may be deployed in the enterprise data center or deployed in Cloud/SDN and managed by the secure enterprise. The DTB 700 provides UI and REST APIs for policy configuration and actions. The “ingest adapter” module 701 receives inputs and notifications from other eco system components and feeds them to the rules engine 702. The “Policy/Rule Builder module 703 generates rules according to configured policies. The rules engine 702 processes the inputs and feeds the results to the “action broker” module 704. The “action broker” module 704 generates triggers and actions as illustrated in FIG. 8.

FIG. 7 shows user plane datapaths connecting to the mobile devices 710 connecting cloud networks through APNs 720 that terminate User Plane tunnels, and forward the user payload packets through the Security Edge Protection Proxies (SEPP) 730 at each mobile operator's network interface to the Public/Private/Cloud/SDN network 760. Mobile devices 710 establish UP tunnels by first establishing a control plane session 715 to the operator's Mobile Management Entity (MME) 740. Each APN 720 corresponds to a different security level SNS or SVPL. User Applications 711 in the mobile device 710 specify the corresponding APN (APN1 . . . 4) in the control protocol while establishing the UP tunnel. The network paths between the SEPPs 730 through the transit multi-domain core network are trust assured according to SNS/SVPL methods. The SNS/SVPL paths 721, 722 from each mobile network could be between different SEPPs 730 or between SEPP 730 and Virtual Functions 750 in Cloud/SDN for cloud hosted servers.

There are multiple example deployments of the Digital Trust Broker.

A first embodiment is the use of a Digital Trust Broker in networks that do not have devices with pre-installed eDCs.

When an enterprise that requires high security needs to connect to a remote site in a country or region, and the access network provider and transit service providers (for example cloud services providers) do not have devices with eDCs already installed, DTB assists in setting up the SNS or SVPL by interacting with the service provider's Operator Management Platforms to obtain device attributes, such as provenance data. Following steps outlines this process.
(1) Network devices use trust validated PKI Digital certificates, that contain Certificate Serial Number, Version, Subject, Algorithm attributes, public key, validity period etc., for trust verification by other devices. The device certificates in prior art may not contain provenance and other security meta data identified in the enhanced Digital Certificates. The devices also contain device attribute and configuration data such as Device Serial Number, Location Address that it is installed, device management IP address and other parameters that are configured by the operator while commissioning the device into their operational network. Operator Management Platforms (OMPs) access and manage configuration data via network management protocols such as NETCONF, SNMPv2/v3 and others. For example, SNMPv2/v3 specify multiple Management Information Bases (MIBs), such as System MIB that contains “sysDescr” that includes system Hardware type, version, and Interface MIB that contains information on each interface. The OMPs construct and manage network topology maps of their network devices using the network management protocols or via other methods such as cable layouts. Operator service personnel use network topology maps for troubleshooting and failure analysis.
(2) An enterprise that requires high security SNS/SVPLs negotiates access to OMPs via ONAP, NETCONF, SNMP or other protocols. The Digital Trust Broker uses the client APIs to establish a secure TLS, SSHv2, HTTPS connection to the operator's OMP, and determines the transit network element addresses (for example management IP addresses) for the entry point to the exit point to the operator network.
(3) The Digital Trust Broker determines attributes of the transit NEs by either securely connecting to each of the transit NEs or obtaining the attributes through the operator's OMP. The device attributes that it collects includes: vendor name, model, and version numbers, manufacturing serial number, and others. If the vendor's support site has additional attributes for the device such as Original Manufacturer, Manufacturing country, region and others, associated with the device, the Digtal Trust Broker collects this information.
(4) The Digital Trust Broker selects the transit NEs that satisfy the security requirements (for example only those from a list of preferred vendors and manufactured in allowed regions) for forwarding path for SNS/SVPL at specific security level. The Digital Trust Broker retains this information for providing source routing for the SNS/SVPL or interacts with the OMP to configure transit route through the operator network.
(5) Since the level of trust created by constructing paths through devices that do not have eDCs is less than with devices with eDCs, the enterprise may use such network paths for lower security levels (for example Low and Medium) only.
(6) The Digital Trust Broker may orchestrate creating a Slice Certificate that includes the transit path map constructed in step 4 above by interacting with an eCA (enhanced Certificate Authority) and storing it in the entry points to the SNS/SVPL.
(7) Additionally, the Digital Trust Broker may create end to end tunnels (TLS, VXLAN and others) through the selected transit network elements.
(8) In addition to the primary forwarding path at each transit hop, the Digital Trust Broker could also configure redundant failover path for hop by hop forwarding. Alternatively for end-to-end transit path (for example, for each SVPL), the Digital Trust Broker could configure a redundant path for primary path failures.
(9) When the traffic from the SNS/SVPL constructed as above needs to interface to SNS/SVPLs at a higher security level, the security policy may require such traffic go through an “Enhanced Security Bridge (eSB)”, similar to interfacing with internet gateway.

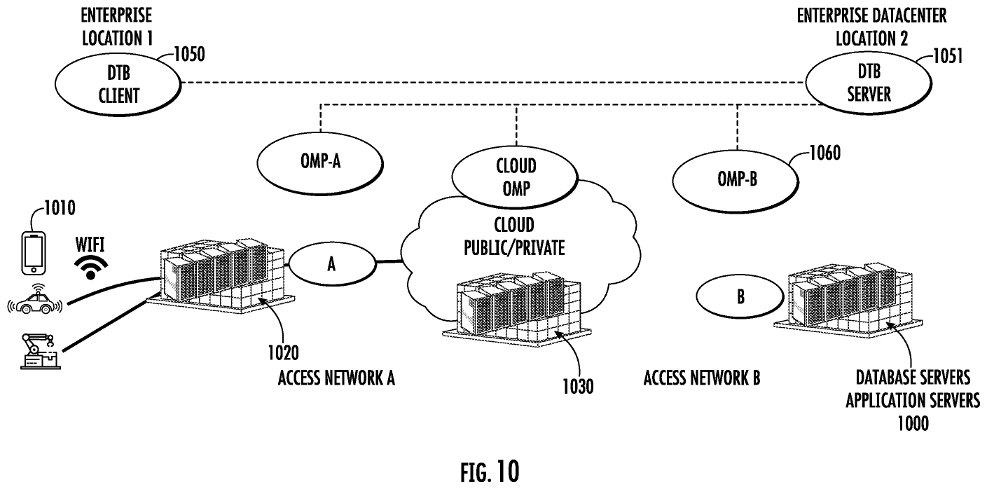

A second deployment is the use of a Digital Trust Broker in brokering trust between a plurality of Authorization and Authentication systems, as shown in FIG. 10.

An enterprise that deals with highly sensitive data may have a plurality of locations (physically secure locations or virtual systems in cloud at different locations/regions for edge computing for reducing round trip latencies to clients). The enterprise manages its own authorization and authentication servers for granting access to users and user devices. The enterprise has multiple departments, such as R&D, Finance, Customer service, and also has database and application servers 1000 that host and manage data at multiple security levels. Thus, communication paths between the multiple security uses require multiple levels of security, which may be achieved using SNS at multiple security levels. Access to highly sensitive data in the datacenter must be severely restricted—thus requiring a high security level SNS for remote accesses to the server; the security levels for such accesses may be different for Read, Write and Modify operations and the security policies may require time limits or volume limits of such operations to minimize security vulnerabilities and prevent modifications of large datasets. Highly sensitive datasets, and servers at the datacenters may have their own authentication and authorization policies, that include monitoring, logging, and validation for audit trails of the data access and modifications.

The enterprise may set up Secure Network Slices at multiple security levels (SL1-Low, S12-Medium, SL3-High) between different endpoints such as mobile devices 1010, enterprise locations 1020, NFV Servers and other devices in SDN/Cloud datacenters 1030 using the methods described in U.S. patent application Ser. No. 17/321,405. The enterprise security and trust policies may allow only the transit network devices that hold enhanced digital certificates with provenance and other security policy metadata as outlined in the above referenced application. Alternatively, an orchestration and trust brokering device, such as DTB 1050, may determine device provenance attributes, Geo location and other parameters in transit service provider networks, and select only compliant devices. When an end user or application attempts to use a SNS at a high security level, the DTB 1050 assists in validating the slice paths as follows:
1. When a user or user application initiates a session, the enterprise authentication and authorization framework uses password protection, Multifactor Authentication, Biometric verification or other techniques, to verify the identity of the user.
2. When the user session attempts to access the SNS, the SNS end point (either user device or CPE device in enterprise location) triggers the DTB 1050 for validation for the specific SNS.
3. The DTB 1050 interacts with CPE device to obtain the security policy metadata of the slice certificate, and determines which applications, departments are allowed to access the specific slice.
4. The DTB 1050 interacts with enterprise authorization and authentication servers to determine the user privileges, user's department, application, and the remote server that client is connecting to. If the privileges do not match, the DTB 1050 rejects the access and notifies the client.
5. Once client privileges are validated for the SNS at a specific security level, for example SL2, the DTB 1050 revalidates the transit path for trust assurance of each transit device.
6. From the transit path map constructed during SNS setup that includes each transit network provider identity, and the identity of each transit NE (such as its Management IP address, its MAC address and other parameters) in the provider network, the DTB 1050 interacts with the service provider's operations and management platform (OMP) 1060, to determine the device's eDC metadata that includes provenance data, HW/SW model numbers, version numbers and other parameters and validates they are same as when SNS was setup. This allows the DTB 1050 to detect if any of the transit NEs have been replaced with other devices or HW/SW versions updated.
7. At the SNS destination end point, for example, at the remote datacenter that hosts application servers, database and storage servers, depending on the specific resource being accessed, the authorization policy server triggers the DTB 1051 for validation of the user, user application, and the type and scope of access (for example, volume of data allowed to be accessed or modified, time duration of access) allowed by the application.
8. The security policy for the server may also require logging and monitoring of the application session for Analytics and anomaly detection. For example, if the analytics system learns that a user, and user application accesses/modifies “M” data records in one session, and a new session starts accessing 10% more records, based on the Rules configured in Rules Engine, the DTB 1051 may send notifications to the policy system, and when the accesses increase beyond 50%, the DTB 1051 may trigger Alarms with different severity levels. The Rules engine 702 (see FIG. 7) facilitates specifying alternative actions for different levels application behavior anomalies.

A third deployment of the Digital Trust Broker is shown in FIG. 8. As shown in FIG. 8, the DTB 700 provides a user interface and common API for validating trust assurance of end to end network paths, individual network segments, transit network elements, application services and others, by interacting with plurality of security and management platforms in the multidomain networks. The input domain 800 for the DTB 700 may include but are not limited to:
Enhanced X.509 Certificates (PKI certificate with metadata extensions)
   Enrollment request metadata
   validation of metadata (including provenance extensions) in eDC
   Revocation metadata
GEO location
   Provided to the DTB by external service or DTB may dip an IP-Based GEO location service
Policy Profile sourced from customer infrastructure or programmed by customer into DTB
   Contains provenance policy and rules (ex. allowable vendors/devices, GEO policy, etc.)
   DTB-Function: In 5G, this info may reside in the UDM and require the DTB to interface and pull from the UDM
Method of gathering device forwarding behavior for specific interfaces for Analytics/ML—Device behavior profile (External inputs or learned behavior)
   Inferences from Analytics algorithms
   Client/Server interaction history, frequency, GEO history, etc.

The action domain 810 that the DTB 700 may perform based on these inputs may include but not limited to:
Compute a “trust score” for an entity based on a plurality of inputs.
   The trust score may be used to influence the OCSP authentication response
   The trust score may be used to trigger actions outside of the PKI infrastructure
Pass back go/no-go recommendation to Security System/Slice Orchestrator while setting SNS or when a specific SNS use is initiated
Example infrastructure action triggers:
   Deregister or block a network function, service or UE
   Restrict to certain classes or service
   Operate in a degraded trust level based on policy, possibly time-limited
Example infrastructure interface types:
   Service Orchestrator
   5G core NRF/UDM; 5G slice PCF/SMF
   Other policy and resource management services
Alert/Alarm infrastructure
   Customer specific frameworks
   Pass forward a “trust score” to a 5G function such as 5G PCF which may tie into whether a NF is allowed to participate in a slice type.

The inputs and actions described above will be described in more detail.

One of the inputs defined above is a method of gathering device forwarding behavior for specific interfaces for Analytics/ML. The device forwarding behavior may be learned from collecting packet header data from device interfaces; this data may include packet volume, byte volumes, frequency, IO Read, IO Write Activity generated during the session, for each client server interaction by the user and user device. Based on learned data, the Analytics module may facilitate anomaly detection by detecting if the device behavior significantly deviates from the past learned behavior. For example, assume when a specific application session interacts with a server, all the outbound packets from client are limited to destination addresses A and B. In a follow-on time interval, if outbound packets to destination “C” are detected, the Analytic system could tag this behavior as an anomaly and trigger additional validation. Alternatively, the analytic system could maintain a list of destination IP addresses the client generates over past sessions, and mark an anomaly if new addresses are seen. Such methods are helpful in detecting security compromises.

Another input relates to Client/Server interaction history. For example, assume a client application/user interacts with application servers in locations “A, B” over a long period of time. The Analytic System maintains a list of servers and their locations by the Client application. If the client application/user accesses servers “C, D” in other locations, the analytic system may tag this access for enhanced validation from enterprise Authentication and Authorization policy servers. After the new Servers and their locations are validated, the Analytic system could add the new servers to the normally accessed server list. Such Application behavior characterization could be per user, and App or for a specific department in the enterprise. For example, users and applications in Finance Department may interact with servers in Location “A” over a period of 6 months, and subsequently start intearctions with a server in location “B”. In this scenario, the Analytic system could report this as a possible Anamoly to the DTB. The DTB, based on the configured Rules in the Rules Engine, triggers additional validation steps and/or generates events/alarms to the eco system components.

Another concept listed above is Trust Score. The history based “trust score” characterizes the current behavior of the application or user session compared to the session behavior learned previously over a period of time. For example, assume that application A from Department “X” daily connects to servers S1, S2 in Location L1, and receives ˜N1 inbound packets and generates ˜N2 outbound packets per session. If application A then generates substantially higher packet volumes, or accesses servers in Location L2, the Analytic System in coordination with the DTB Rules Engine could generate additional validation and/or triggers.

When a user/client application initiates a traffic through SNS/SVPL at a specific security level, the enterprise or service provider network authenticates and authorizes the user and User device for the network slice use. As the user establishes TLS connections through secure network path, the DTB collects the session usage information such as frequency of use, up/down packet and byte volume, the addresses of remote servers it connects to, and certificate validation information for each client server pairs. Based on this information, the Analytics function estimates the trust score, for example (High, Med, Low). It propagates the trust score to the security system components such as OCSP server, to influence and expedite certificate revocation/validation responses. Similarly, the DTB computes trust scores for NFs such as Application servers/proxies, based on certificate meta data and its behavior patterns, such as its interaction with other servers and ecosystem components, Read/Write IO operations, and passes the trust score to 5G policy functions (PCF) that controls access to the SNS at specific security level.

The Digital Trust Broker 700 may be used for revalidating transit paths in the multi-domain network due to configuration and path changes.

Transit networks that carry SVPL/SNS traffic predominantly use destination-based forwarding at L2 or L3 at each hop in each operator/service provider network. Whether the forwarding uses a routing protocol, or is set up by a network controller, it may use destination addresses below the slice operational level. When an interface goes down or a service provider moves virtual elements for load balancing and resource optimizations, it is essential that security policies used at the time of setting up network slices are revalidated and re-assured. This may be achieved by tagging only those virtual and physical devices and specific interfaces with eDCs as allowed for traffic-rerouting at the time of setting up secure network slices. Alternatively, when an interface goes down or configuration changes happen due to resource load balancing reasons, the corresponding physical or virtual interface assures blocking slice traffic through that port, returns an error towards the source, and notifies the SNS-OMP 401. SNS-OMP 401 interacts with DTB 403 to communicate with operator management platforms to determine compliant transit network devices and sets up new transit network paths for the secure network slices.

When a client application initiates traffic, such as initiating an encrypted connection to a remote server through a SNS that is already setup, the client and server verify mutual trust via well-known PKI methods. However, the transit paths that the packets go through for the specific SNS is unknown to the client. While the transit paths were trust verified to ensure each transit network element holds and is compliant with the eDCs, a high security client may want to re-validate transit path trust before, during, or after SNS use. Such path verification requires identifying each transit NE of the SNS path in each of the transit service provider or cloud networks. The DTB 700 provides an API for enterprise clients for transit path validation. The DTB interacts with each of the operator's Operation and Management platforms to determine transit NEs and their compliance to SNS requirements. This process is similar to the process while setting up SNS, with the difference that since SNS paths are already setup, and allowed devices are known, the DTB 700 only verifies those devices. Since devices or layered host-OS, VMs and other components may be upgraded after SNS setup, the revalidation steps ensure compliance at the time of SNS use.

Slice Certificates

A SVPL or SNS is a logical network path that is set up through compliant network devices that hold eDCs. The policies that the network path assures and security policies for accessing and using the network path (such as which users, departments, user devices, applications are authorized) may be orchestrated by a Slice Certificate. It is envisioned that once an enterprise defines policies for a SNS or SVPL at specific security level, the policies change infrequently. Thus, slice certificates may be created via Certificate Authorities (CAs). For example, an organization defines policies on which department, and level of security clearance required for users for accessing a sensitive database in a datacenter with perimeter security. Further, in order to make that database available to other locations, the organization defines security policies that the transit network must conform to and creates a slice certificate for that security level.

Assuming the secure network slices terminate in the customer premise equipment (CPE) at each enterprise location, the slice certificates are stored in the CPEs. Whenever an application attempts to use SNS, for example, when an application tries to establish a TCP connection to a remote Database server or attempts to resolve the domain name of remote server to an IP address, the CPE interacts with the DTB, and the DTB validates that the client and application credentials meet the specific slice access policy requirements. This prevents un-authorized sessions/accesses at the entrance to the slice, thus protecting remote slice endpoints from security breaches, DOS/DDOS attacks etc. The security policy requirements at the datacenter may be stricter, for example which departments and clients could modify specific data segments, and which manager or department or authority should grant such authorization and granularity, and the duration of such access (similar to accessing a lock box in a bank). Thus, after the connection is established, and a modify operation is initiated, the remote CPE notifies the DTB, and the DTB verifies whether the specific slice security level and the client application and user are allowed to modify the data by interacting with enterprise authorization policy servers.

### Orchestration of Security Platform Components for SVPLs and Secure Network Slices

U.S. patent application Ser. No. 17/321,405 identifies opportunistic placement of security system components such as eCA, enhanced OCSP server and others, and that support eDCs with metadata extensions to minimize latencies, such that they are close to client locations that are dependent on eDCs. Such placement requires certificate validation flows (such as OCSP Requests, Responses), and identifying the frequency of such flows and identifying Geo locations, which type, class, range of certificate information need to be shadowed by Virtual or Proxy security system components placed at the edge. The DTB assists in this process by interacting with operator management platforms to receive certificate flow information. For example, an enhanced CA in a physically secure location manages issuing and distributing eDCs with relationships with other security system components in multi-domain network. The SNS-OMP 401 function of Secure Operations Center 400 (FIG. 4) receives and tracks real-time flow of enhanced certificates and feeds this information to the Analytics Platform 404. The DTB 403 in coordination with Analytics Platform 404 orchestrates placement of virtual security platform components in Cloud and Virtual Networks such as AWS, Google GCP and others to reduce round trips in validating certificates and identifying expired or revoked certificates.

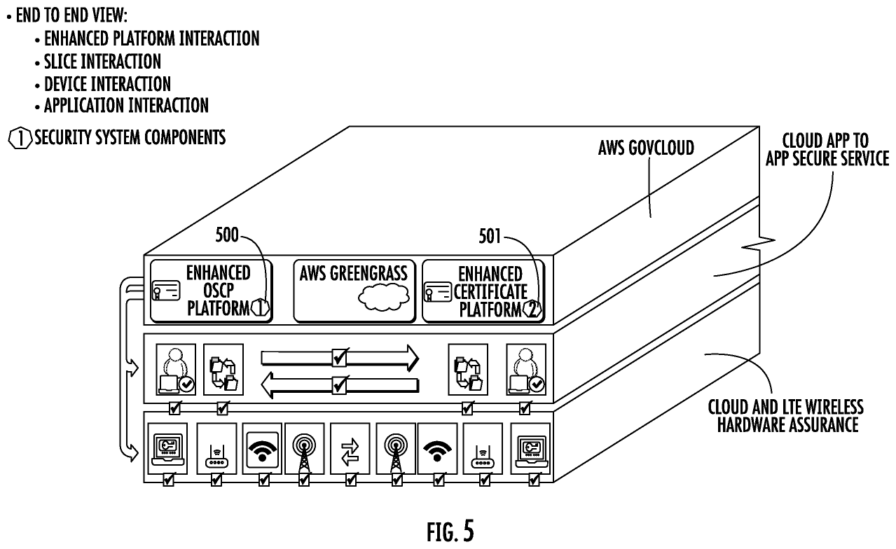

FIG. 5 shows an example of virtual security platform components in AWS Government Cloud Infrastructure. The eCA uses Clustered hardware security modules (HSM) and serves as a multi-region, secure CA platform and supports App security authenticity and authentication. It supports hardware security authenticity & authentication. The enhanced OCSP Platform functions as multi-region OCSP server. The OCSP Platform 500 and the Certificate Platform 501 shown are software modules (VNFs) that use the methods disclosed herein and use infrastructure HW and SW services. These platforms work in coordination with the Multi-Domain Security System components in physically secure locations. The OCSP Platform 500 and the Certificate platform 501 maintain shadow copies of certificate related information such as revocation, validity periods and other parameters, to reduce end to end round trips for certificate retrieval and validations to achieve “Near Zero Latency (NZL)”.

The orchestrated security system component supports low latency certificate validation of device certificates (for example for IOT devices), layered software, and Cloud services. The enhanced security system components, such as the OCSP platform 500 placed in AWS Greengrass facilitates automated low latency certificate validation and assurance of hardware/vendor type, and provides encrypted, authenticated network communications. The platform components such as OCSP platform 500, use shadow copy in the OS that it is running on and use proxy, caching, prefetching and other techniques to maintain certificate, validity and revocation information of interest relative to its location. Using Analytics/Learning Algorithms and opportunistic shadow copying using underlying OS to locate certificate data close to the endpoints that use the specific certificates, these platforms reduce round trips and latency. These shadow copies may be managed by the OCSP proxy methods within the OCSP Platform 500 and the Certificate platform 501 shown in the figure.

Shadowing in AWS Greengrass copies security related and other data from IOT Client device for cloud applications at the edges to facilitate computing at the edge and share across relevant applications. The objective of shadowing in the virtual security components is to minimize round trips and reduce latency for flows related to enhanced certificates. This is achieved by maintaining copies of digital certificates from devices either including private keys or not including private keys. Additionally, data from server or from remote security platform components copied to virtual security platform components in Cloud VPC closer to clients in an opportunistic way, prefetching/Caching in OCSP (based on learning) using Analytics/ML.

Security Platform Component that Enforces the Security Methods for Internet Traffic

Client Applications and/or application servers of security enterprises that use SNS/SVPLs may require internet connectivity. This may require traffic from one or more secure network slices or SVPLs (for example, an SVPL from a transit NE) of an enterprise sending or receiving traffic to/from internet. To minimize security vulnerabilities, the present disclosure teaches that this traffic is first forwarded to a Physical/Virtual Security System Component termed eSB 301 (Enhanced Security Bridge), that is compliant with the eDCs and additional security policies specific to eSB functions. The eSB performs client specified and enterprise required policies such as Firewall rules, caching/proxy functions, obfuscation, and others. Firewall policies in the prior art specify allowed/blocked TCP/UDP ports, websites, applications, application features, such as cookies. The current methods identify additional security policies such as only a SVPL or SNS at certain security level is allowed to interface with the internet. Alternatively, only specific applications or application servers (such as VNFs) that hold enhanced digital certificates according to the methods described herein are allowed to send/receive internet traffic. User Sessions or network sessions (such as from proxies) could be tagged with security level when the session is established, and only sessions with a certain security level may be allowed to interact with internet. This way, when a user is accessing systems and resources at higher security level, the user will not be sending/receiving internet traffic thus protecting the network from security vulnerabilities from the internet. These policies are enforced by the eSB while forwarding between SNS and internet or between multiple SNS and SVPLs at different security levels. Additionally, the eSB could log, perform audit functions, and run real-time analytics functions by running classification and learning algorithms for detecting anomalies. The example policies that eSB must support include but not limited to:
(a) only specific SVPL or SNS at a specific Security level could interface to internet;
(b) specific SVPL/SNS end points allowed to connect to internet;
(c) Could only connect to Specific Internet servers;
(d) Specific users allowed per enterprise authentication/authorization policies;
(e) Should support application server and split-tcp proxy functions;
(f) Should support terminating HTTPS or encrypted sessions, validate content and use another encrypted session to internet server to prevent security vulnerabilities, BOTNET attacks and other issues;
(g) eSB also serves as a gateway to control traffic between multiple SNS or between SNS and SVPLs.

As noted above, the DTB, eSB and the methods identified herein may be implemented in a hardware system or a software module that runs on common hardware or distributed software modules that run on Cloud or SDN frameworks.

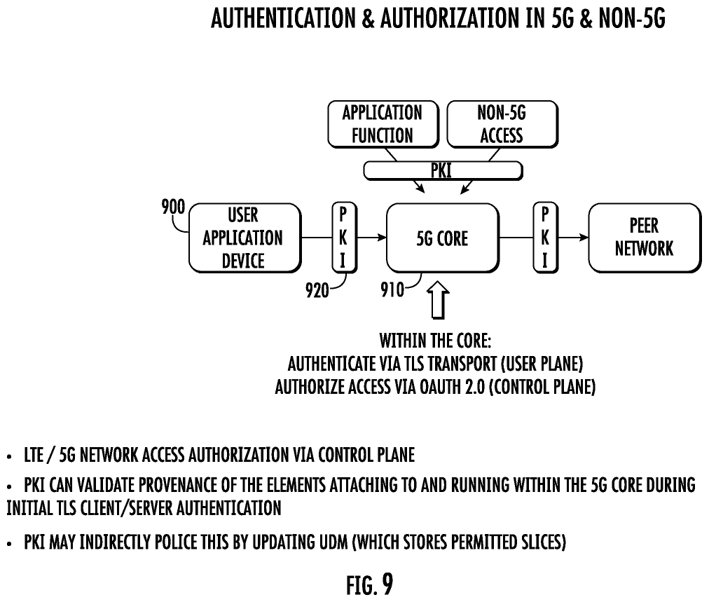

FIG. 9 shows overview of authentication and authorization frameworks in 5G and Non-5G networks. When a user device 900, such as a Mobile phone, attempts to access mobile radio network, the mobile network authenticates the user device and user service access policies by validating SIM/eSIM (Subscriber Identity Module or electronic SIM) and establishes a control plane session between user device 900 and the Core Access and Mobility Management Function (AMF). The user device 900 establishes user plane tunnel through the mobile radio and core networks to the user plane function or access point name (UPF/APN). The UPF/APN terminates the user plane tunnel and forwards to the destination through the core network. If user application uses encrypted sessions, such as TLS or HTTPS, to the destination servers, the two endpoints authenticate each other using PKI/Digital certificates over the user plane tunnel through the transit network. The TLS authentication is at the two endpoints, and the session may traverse through multiple transit network elements. High security enterprises may use secure network paths (SVPL, SNS) with transit path trust validation of transit NEs that allows only certain network elements, as orchestrated by eDCs. The DTB assists User Data Management (UDM) by identifying which SNS network paths are allowed to carry the user plane traffic after the user plane tunnels (GTP-u) terminate. In LTE and 5G, network access authorization is provided via the control plane. The PKI 820 may validate the provenance of the network elements attached to and running within the 5G core 910 during initial TLS client/server authentication. The PKI 920 may indirectly police this by updating the UDM, which stores permitted slices.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of creating a Secure Network Slice, which is a multi-point secure network, comprising:
creating a plurality of secure virtual private lines, wherein creating each secure virtual private lines comprises:
determining one or more forwarding paths through the network that connects two points;
querying each network device along each of the one or more forwarding paths to determine if each network device is trust assured and comprises an enhanced digital certificate, wherein the enhanced digital certificate comprises metadata regarding a provenance of the network device;
defining the secure virtual private line as a forwarding path between the two points wherein each network device in the forwarding path has an enhanced digital certificate having desired parameters; and
using an aggregation device to connect two or more secure virtual private lines to create the Secure Network Slice.

2. The method of claim 1, wherein the multi-point secure network comprises at least one of an enterprise network, a cloud provider, a communications service provider, a SDN, physical/virtual network segment, a 5G radio access network and a 5G core network.

3. The method of claim 1, wherein the metadata is selected from the group consisting of hardware or software make; hardware or software model or release; a region where the network device is manufactured; and a location where the network device is manufactured.

4. The method of claim 1, wherein the metadata comprises geolocation information regarding where the network device is deployed.

5. The method of claim 1, wherein the metadata comprises a list of security policies supported by the network device.

6. The method of claim 1, wherein the two of more secure virtual private lines are at different security levels and the aggregation device comprises an enhanced security bridge.

7. The method of claim 1, wherein a mobile device is configured to access the secure network slice, and the mobile device comprises an enhanced digital certificate and authenticates a user of the mobile device prior to allowing access to the secure network slice.

8. The method of claim 7, wherein the user is authenticated using at least one of multi-part authentication, device screen lock pass code, speaker recognition, fingerprint recognition, and facial recognition.

9. A method of maintaining security in a Secure Network Slice, which is a multi-point secure network, comprising:
creating a Secure Network Slice, wherein the Secure Network Slice includes an enhanced security bridge, wherein the enhanced security bridge serves an interface between other devices in the Secure Network Slice and the internet; and
forcing any traffic from the Secure Network Slice to or from the internet to pass through the enhanced security bridge.

10. The method of claim 9, wherein the enhanced security bridge is configured to perform deep packet inspection.

11. The method of claim 9, wherein the enhanced security bridge only allows traffic at a certain security level to access the internet.

12. The method of claim 9, wherein the enhanced security bridge allows only certain end points to access the internet.

13. A Digital Trust Broker, comprising a plurality of functional software modules;
wherein the Digital Trust Broker is adapted to interact with an Operations and Management Platform (OMP) associated with an external operator to create and maintain a Secure Network Slice, wherein the Secure Network Slice is a logical network in a multi-domain network.

14. The Digital Trust Broker of claim 13, wherein when a user session attempts to access the Secure Network Slice, the Digital Trust Broker validates the user.

15. The Digital Trust Broker of claim 13, wherein when a user session attempts to access the Secure Network Slice, the Digital Trust Broker interacts with consumer premise equipment (CPE) to obtain security policy metadata of a Slice Certificate, and based on the Slice Certificate, determines which applications and departments of an enterprise are allowed to access the Secure Network Slice.

16. The Digital Trust Broker of claim 13, wherein the Digital Trust Broker gathers device forwarding behavior for specific interfaces in the Secure Network Slice, and based on historical information, detects an anomaly in an operation of the device.

17. The Digital Trust Broker of claim 16, wherein the Digital Trust Broker monitors packet volume, byte volumes, frequency, IO Read, IO Activity generated during a session, for each client server interaction by a user and user device.

18. The Digital Trust Broker of claim 13, wherein, after the Secure Network Slice has been created, the Digital Trust Broker creates new transit paths due to configuration changes.

19. The Digital Trust Broker of claim 13, wherein, after the Secure Network Slice has been created, the Digital Trust Broker revalidates each device in the Secure Network Slice.
